(19) United States
(12) Patent Application Publication
(10) Pub. No.: US 2014/0048238 A1
(43) Pub. Date: Feb. 20, 2014

(54) Frameless Heat Exchanger

(71) Applicants: Dongming Tan, Dunlap, IL (US); Changrui Cheng, Katy, TX (US); Thomas Ausman, Germantown Hills, IL (US); Jianlong Xu, Peoria, IL (US); Neil Terry, Edelstein, IL (US)

(72) Inventors: Dongming Tan, Dunlap, IL (US); Changrui Cheng, Katy, TX (US); Thomas Ausman, Germantown Hills, IL (US); Jianlong Xu, Peoria, IL (US); Neil Terry, Edelstein, IL (US)

(73) Assignee: CATERPILLAR INC., Peoria, IL (US)

(21) Appl. No.: 13/585,462

(22) Filed: Aug. 14, 2012

(51) Int. Cl. F28F 9/02; B23P 19/04

(52) U.S. Cl. 165/173; 29/402.01

(57) ABSTRACT

A frameless heat exchanger for transferring heat from a fluid circulating therein to a surrounding environment is arranged and interconnected to accommodate thermal expansion and contraction of its parts. The heat exchanger includes a plurality of hollow tubes each extending between a first end and a second end. The tubes are arranged into a tube core where the tubes are parallel to and aligned with each other so that the first ends align and the second ends align. The tubes are joined along their first ends by a first manifold and along their second ends by a second manifold. The plurality of tubes and the first and second manifolds are interconnected for relative movement between the plurality of tubes to accommodate thermal expansion and contraction of the plurality of tubes.

### TECHNICAL FIELD

This patent disclosure relates generally to a heat exchanger and, more particularly, to a heat exchanger in which thermal energy from fluid in a plurality of tubes is transferred to the surrounding environment.

### BACKGROUND

Heat exchangers are used in a variety of applications to transfer heat from one medium to another. A common application may be to cool a fluid for reuse in a process or application that initially heated the fluid. For example, an internal combustion engine may be associated with a heat exchanger to cool a fluid coolant that has been circulated through the engine to remove heat generated by the internal combustion process. Heat exchangers are also available in a wide variety of configuration. One common configuration includes a plurality of hollow tubes bundled together in which the process fluid can circulate before being returned to the process. In the example of the internal combustion engine, the medium to which heat is transferred to may be the surrounding environment.

A problem associated with heat exchangers arises from the thermal expansion and contraction of materials and the fact that heat exchangers by design transfer thermal energy between circuits or regions at different temperatures. The thermal difference may cause non-uniform dimensional changes in the interconnected parts of the heat exchanger that could heighten thermal stresses between co joined parts and which could lead to rupture or failure. One approach to mitigating the problem of thermal stress buildup in heat exchangers is described in U.S. Application Publication 2008/0011456 titled “Heat Exchanger Having Integral Elastic Regions.” The '456 publication describes using elastic sleeves or regions to interconnect different components of a heat exchanger that might be at different temperatures. The elastic regions can distort or displace to accommodate dimensional differences caused by non-uniform thermal dynamic expansion or contraction of the parts. The '456 publication, however, can require complex joining techniques to attach the different materials and requires additional elastic parts at an added cost. Accordingly, there is a need for an improved heat exchanger.

### SUMMARY

The disclosure describes, in one aspect, a frameless heat exchanger including a plurality of tubes each extending between a first end and a second end. The plurality of tubes are arranged parallel to and aligned with each other to form a tube core. Each tube can be attached to an adjacent tube at the respective first and second ends. At least some of the plurality of tubes are in fluid communication with adjacent tubes in the tube core at the first ends to form a first manifold and at least some of the plurality of tubes are in fluid communication with adjacent tubes at the second ends to form a second manifold. The plurality of tubes and the first and second manifolds are interconnected for relative movement of the plurality of tubes to accommodate thermal expansion and contraction of the plurality of tubes.

In another aspect, the disclosure describes a method of assembling a frameless heat exchanger. The method includes forming a plurality of elongated, hollow tubes with each tube extending between a first end and a second end. The method further involves arranging the plurality of tubes into a tube core where each tube is substantially parallel to and longitudinally aligned with each other tube. The tubes are further arranged so that the first ends are aligned along a first side edge of the tube core and the second ends are aligned along a second side edge of the tube core. The method secures the plurality of tubes together by joining the first ends with each other and joining the second ends with each other such the primary structural connection between the plurality of tubes is at the first ends and the second ends.

In further aspect, the disclosure describes a frameless heat exchanger for transferring heat from a fluid circulating therein to a surrounding environment. The heat exchanger includes a plurality of elongated, straight hollow tubes extending between a first end and a second end to define a longitudinal axis. The plurality of tubes are arranged substantially, parallel to and aligned with each other along their longitudinal axes to form a tube core. Each tube may have a generally flat cross-section normal to the longitudinal axis with the flat-cross section defining opposing upper and lower surfaces of the tube. A cup-shaped upper boss may be disposed at each of the first and second ends protruding upwards from the upper surface. Additionally, a cup-shaped lower boss is disposed at each of the first and second ends protruding downwards from the lower surface. The upper bosses and the lower bosses are aligned at the first ends to form a first bellows manifold, and the upper bosses and the lower bosses are aligned at the second ends to form a second bellows manifold. The tube core is structurally supported by the plurality of tubes and the first and second bellows manifolds

### BRIEF DESCRIPTION OF THE DRAWINGS

FIG. 1 is perspective view of a prior art heat exchanger including a plurality of tubes extending between an inlet manifold and an outlet manifold supported by a frame having a top plate, a bottom plate and side plates.

FIG. 2 is a perspective view of a frameless heat exchanger in accordance with the disclosure to accommodate thermal expansion or contraction of the plurality of tubes.

FIG. 3 is cross-sectional view taken along lines 3-3 of FIG. 1 illustrating the tubes including a reinforced first tube and standard second tubes.

FIG. 4 is a front plan view of the frameless heat exchanger with the plurality of tubes in thermal expansion and with flexible manifolds bent in a generally convex manner.

FIG. 5 is a front plan view of the frameless heat exchanger with the plurality of tubes in thermal contraction and with flexible manifolds bent in a generally concave manner.

FIG. 6 is a detailed view of one side of the frameless heat exchanger illustrating the plurality of tubes interconnected to each other by a bellows-style manifold.

FIG. 7 is a perspective cutaway view of the inside of the bellows-style manifold taken along lines 7-7 of FIG. 6 illustrating communication passageway for fluid to flow through the manifold.

FIG. 8 is a cutaway plan view taken along lines 8-8 of FIG. 6 illustrating an upper boss and a lower boss joined to form a bellows disposed between adjacent tubes of a heat exchanger.

FIG. 9 is a schematic representation of one possible single pass flow path through the frameless heat exchanger.

FIG. 10 is a schematic representation of another possible multipass flow path through the frameless heat exchanger.

FIG. 11 is a perspective view of the frameless heat exchanger including first and second side brackets flexibly attached about the manifolds for installation purposes.

### DETAILED DESCRIPTION

This disclosure relates to heat exchangers for exchanging heat between two or more mediums, typically fluids. Although the specific examples of heat exchangers described herein are typically intended for use with internal combustion engines, heat exchangers in accordance with the disclosure can more broadly be used in any appropriate application or process such as heating and cooling applications, energy production, chemical and material processing, etc. The specific heat exchangers described herein typically function by transferring heat from a first fluid circulating inside the heat exchanger to a second fluid such as atmospheric air surrounding and flowing over the surfaces of the heat exchanger. The transfer mechanism is commonly referred to as convection although the specific details of the thermodynamic transfer mechanism should not be considered a limitation on the claims. In some embodiments, the process may be reversed so that heat from the surrounding environment is transferred to the fluid circulating in the heat exchanger to raise its temperature.

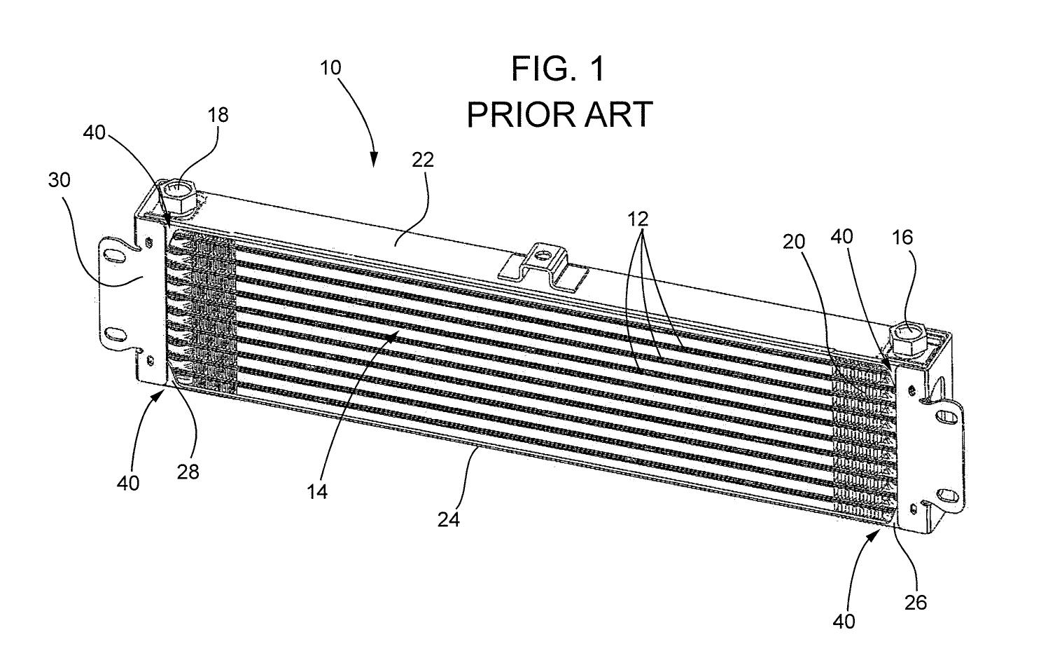

Referring to FIG. 1, wherein like reference numbers refer to like elements, there is illustrated a prior art example of a heat exchanger 10 that may be used with a process, such as in connection with an internal combustion engine. The heat exchanger can be used to cool engine coolant, lubricating oil returning from the engine block, or in positive pressure fuel injected systems fuel returning from the fuel injector circuit. To channel the fluid to be cooled, the heat exchanger 10 includes a plurality of hollow, elongated tubes 12 that can be arranged longitudinally, spaced apart, and parallel to each other in what may be referred as a tube core 14. The tubes 12 extend between a first manifold 16 and a second manifold 18 disposed at the sides of the tube core 14. The first manifold 16 can function as an intake manifold receiving heated fluid from the process and the second manifold 18 can function as an outlet manifold returning the cooled fluid to the process. To promote cooling, the heat exchanger can include thin-walled fins 20 that are located in the spaces between the parallel tubes 12.

To structurally support and protect the tubes 12, the first and second manifolds 16, 18, and the thin-walled fins 20, the prior art heat exchanger 10 includes a top plate 22, an opposing bottom plate 24 and first and second side plates 26, 28 that are arranged about and rigidly secured to the tube core 14. The plates 22, 24, 26, 28 can be made from rigid, structural steel and can be welded together to form a support frame 30 disposed about the rectangular perimeter of the tube core 14. Welding, rivets and/or threaded fasteners can be used to rigidly attach the support frame 30 to the tube core 14 and first and second manifolds 16, 18. The plates 22, 24, 26 and 28 can be made from the same or different materials as the tubes 12 and can have different thickness dimensions.

A problem arising with the prior art heat exchanger 10 is that the tubes 12 and the manifolds 16, 18 may undergo thermal expansion and contraction due to the heated fluids circulating therein in a non-uniform manner with respect to the support frame 30. For example, the parallel tubes 12 may increase in length by a larger dimension than the top or bottom plates 22, 24, which are not in direct contact with the heated process fluids, causing thermal and mechanical stresses to build in the heat exchanger as the support frame 30 constrains the enlarged tubes. Additionally, the support frame 30 may be made of a different material having a different coefficient of thermal expansion than the tube 12 or may have different dimensions so as to respond differently than the tubes. These stresses can concentrate in stress regions 40 located proximate to the joints and attachment points between the tube core 14 and the support frame 30 which may occur at the four corners of the rectangular support frame. If severe enough, the thermal stresses can cause the joints and/or attachment points to fracture or rupture leading to failure of the heat exchanger. Similar problems arise if the process is reversed and the fluid circulating in the tubes is cooled with respect to the environment. As described above, prior art methods to mitigate this problem often involve the use of elastic joints and the like, with resulting drawbacks.

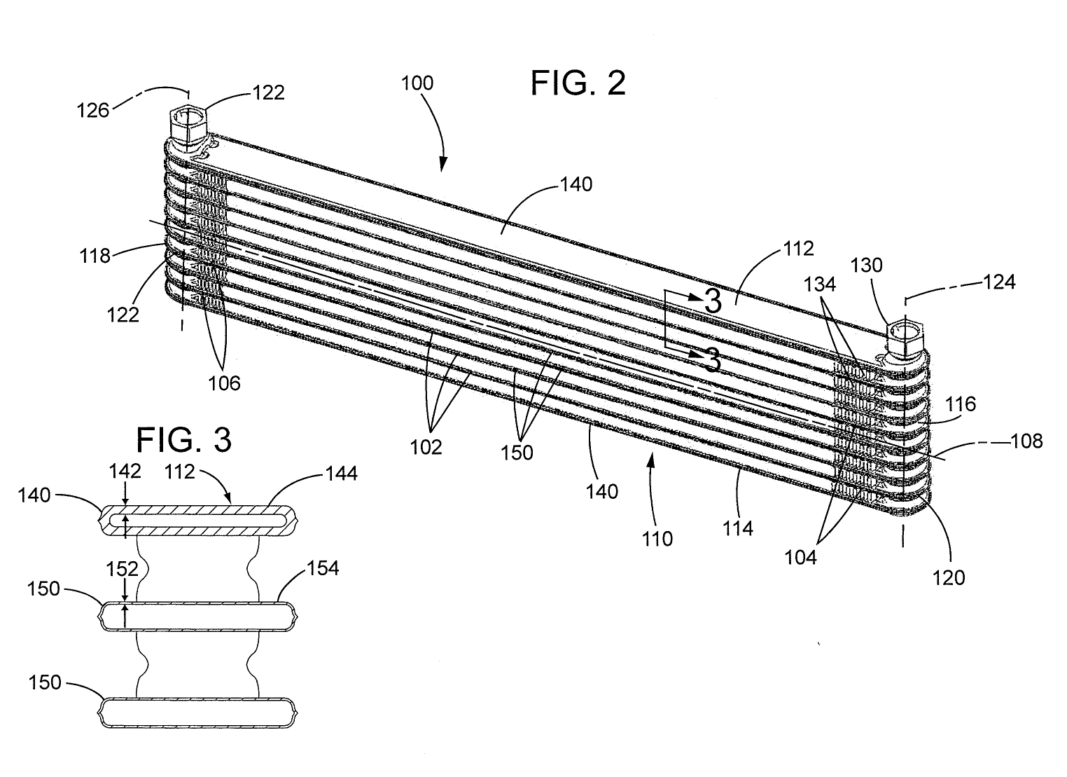

Referring to FIG. 2, there is illustrated a heat exchanger 100 in accordance with the disclosure that can accommodate the thermal expansion and contraction of the parts to mitigate the effect of thermal and mechanical stresses. The heat exchanger 100 includes a plurality of elongated tubes 102 that are arranged in parallel and spaced apart from each other to form a tube core 110. To channel or direct fluid therein, the tubes 102 are hollow and can be made from a thin-walled material such as aluminum or another metal. Each tube 102 includes a first end 104 and an opposite second end 106 thereby defining a longitudinal axis or longitudinal direction 108 of the tubes and the heat exchanger. The plurality of tubes 102 can be aligned along their longitudinal direction 108 and their lengths are such that the first ends 104 coextensively align together and the second ends 106 coextensively align together. The tube core 110 therefore has a generally rectangular shape including a top edge 112, a parallel bottom edge 114, a first side edge 116 formed by the aligned first ends 104 and a parallel second side edge 118 formed by the aligned second ends 106 with both side edges normal to the top edge and bottom edge.

To establish fluid communication between the heat exchanger 100 and its associated process or application, the heat exchanger can include a first manifold 120 disposed along the first side edge 116 of the tube core 110 and a second manifold 122 disposed along the second side edge 118. The first and second manifolds 120, 122 can be generally vertical and define a respective first manifold axis 124 and a second manifold axis 126. Further, the first and second manifolds 120, 122 can extend along the height of the tube core 110 so that they are perpendicular to the plurality of tubes 102 and the first and second manifold axis 124, 126 are perpendicular to the longitudinal direction 108 of the tubes. The first manifold 120 can function as an intake manifold receiving heated fluid from the process and directing it to the tubes 102 and the second manifold 122 can function as an outlet manifold receiving the cooled fluid from the tubes and returning it to the process. To physically connect with hose lines or such from the associated process, the first manifold 120 and the second manifold 122 can include a respective first and second threaded hose fittings 130, 132 disposed proximate the top edge 112 of the tube core 110.

Fluid can circulate through the heat exchanger 100 by entering the first manifold 120, passing longitudinally through the tubes 102, and exiting the second manifold. Air or another medium moving or flowing perpendicularly to the tube core 110 can pass through the spaced-apart tubes 102, adsorbing heat by convection and transferring the absorbed heat away from the heat exchanger 100. To facilitate heat transfer by increasing the surface area available for cooling, a plurality of fins 134 may be disposed between the spaced-apart tubes 102 and may extend between the first and second manifolds 120, 122. The fins 134 can be formed from thin-walled corrugated metal undulating between adjacent tubes 102 conveying the heated fluid.

To accommodate or militate against thermal cycling, the resulting dimensional changes, and thermal stress buildup, the heat exchanger 100 can be designed so that the tubes 102 can freely expand and contract along their longitudinal axes 108 with respect to each other and the first and second manifolds 120, 122. In one embodiment, this can be accomplished by eliminating the support frame including the top and bottom plates and the side plates. The support frame therefore no longer constrains expansion of the bundle of tubes. The individual tubes 102 are free to expand and contract along their longitudinal direction 108 to reestablish the lengthwise dimension of the tube core 110 given by the distance between the first and second side edges 116, 118. Additionally, elimination of the support frame also eliminates the attachment points and joints where thermal and mechanical stress could concentrate.

In this embodiment, the plurality of tubes 102 in the tube core 110 is generally self-supporting and provides structural rigidity for the heat exchanger 100. To increase structural rigidity in the absence of the support frame, one or more tubes among the plurality of tubes can be reinforced and can accommodate increased structural loads. In particular, referring to FIGS. 2 and 3, the plurality of tubes 102 can be categorized into groups of reinforced first tubes 140 and standard second tubes 150. Both the reinforced first tubes 140 and the standard second tubes 150 are hollow to delineate an internal channel through which fluids can flow. To reinforce the reinforced first tube 140, the first thickness 142 of the first tube wall 144 can be increased with respect to the second thickness 152 of the standard second tube wall 154. Alternatively, the reinforced first tube 140 can be manufactured by a different process, such as extrusion, which provides better structural integrity than the standard second tubes 150 that can be manufactured by welding. Further, the extruded tube may include an internal webbing disposed about its internal surfaces adjacent to the tube wall to improve pressure loading. The reinforced first tube 140 can be made of a stronger material than that standard second tube 150, such as steel compared to brass or copper, or the reinforced first tube can be made of a stronger grade of the same material as the standard second tube, such as aircraft grade aluminum compared to normal aluminum.

In one embodiment, the reinforced first tube 140 can be disposed along the top edge 112 of the tube core 110 while the standard second tubes 150 can make up the remainder of the tubes in the tube core. In a further embodiment, another reinforced first tube 140 can be disposed along the bottom edge 114 of the tube core 110. In yet a further embodiment, at least three reinforced tubes 140 can be disposed throughout the tube core 110, e.g., along the top edge 112, the bottom edge 114 and therebetween. The reinforced first tubes 140 provide structural rigidity to maintain the rectangular shape of the heat exchanger while allowing for relative expansion and contraction of the standard second tubes 150 in the lengthwise direction. The reinforced first tubes 140 can act as the primary structural support in the longitudinal direction 108 between the spaced-apart first and second manifolds 120, 122. The reinforced first tubes 140 may also function to absorb or redirect the thermal stresses along the longitudinal direction 108. Additionally, the fins 134 can be removed from an uppermost surface of the first tubes 140 along the top edge 112 and from a lowermost surface of a first tube at the bottom edge 114 to simplify handling and prevent their damage.

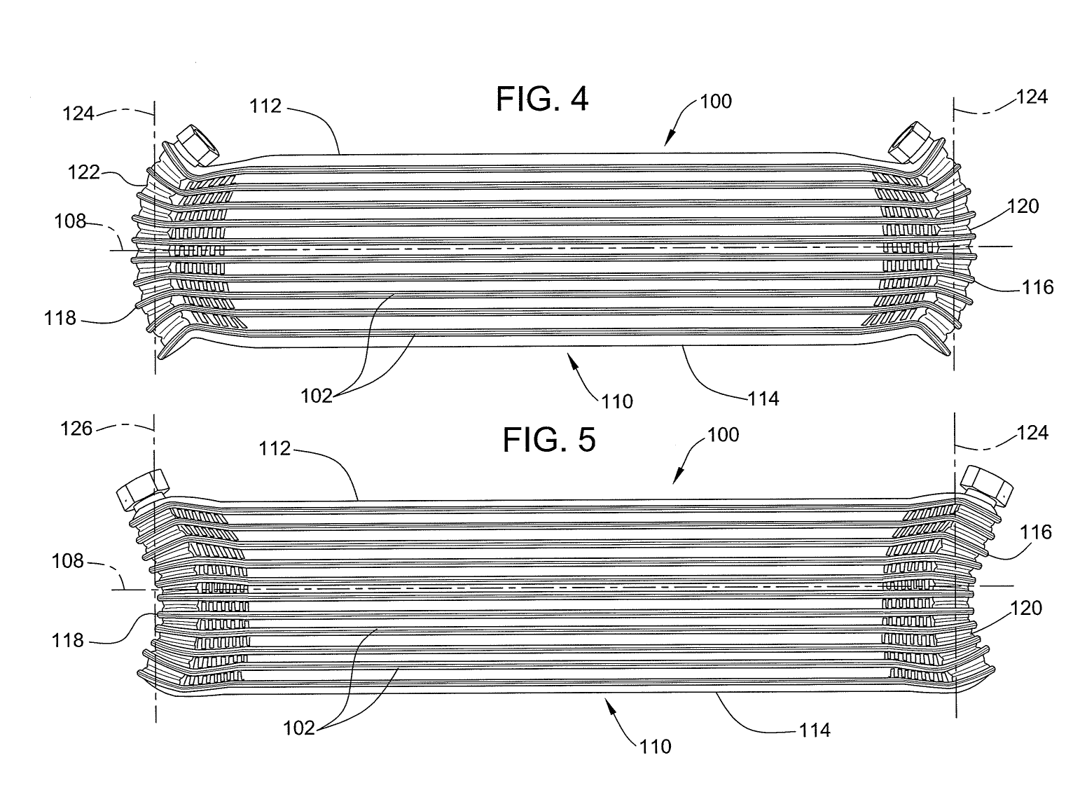

To further accommodate expansion and contraction of the tubes 102, in the embodiment illustrated in FIGS. 4 and 5, the first and second manifolds 120, 122 can have a relative degree of flexibility to bend or distort in conjunction with the change in dimensions of the tubes. It should be understood that the degree of bending shown in FIGS. 4 and 5 may be exaggerated for descriptive purposes. More specifically, referring to FIG. 4, the first manifold 120 is sufficiently flexible to displace itself with respect to the normally vertical first manifold axis 124. The second manifold likewise is sufficiently flexible to displace with respect to the vertical second manifold axis 126. The first and second manifolds 120, 122 are further mechanically attached along or coupled to the respective first and second side edges 116, 118 of the tube core 110 so they can bend or displace outward from the tube core as the tubes 102 expand in length and the heat exchanger 100 assumes a generally convex shape. Conversely, if the process is reversed with cooler fluid circulating in the heat exchanger such that the tubes 102 contract in length the first and second manifolds 120, 122 can flex or bend inwards with respect to the vertical first and second manifold axes 124, 126 in conjunction with the shrinking tube core 110 and the heat exchanger 100 assumes a concave shape. Elimination of the support frame in these embodiments facilitates bending of the flexible manifolds since they are generally free to displace with the tubes.

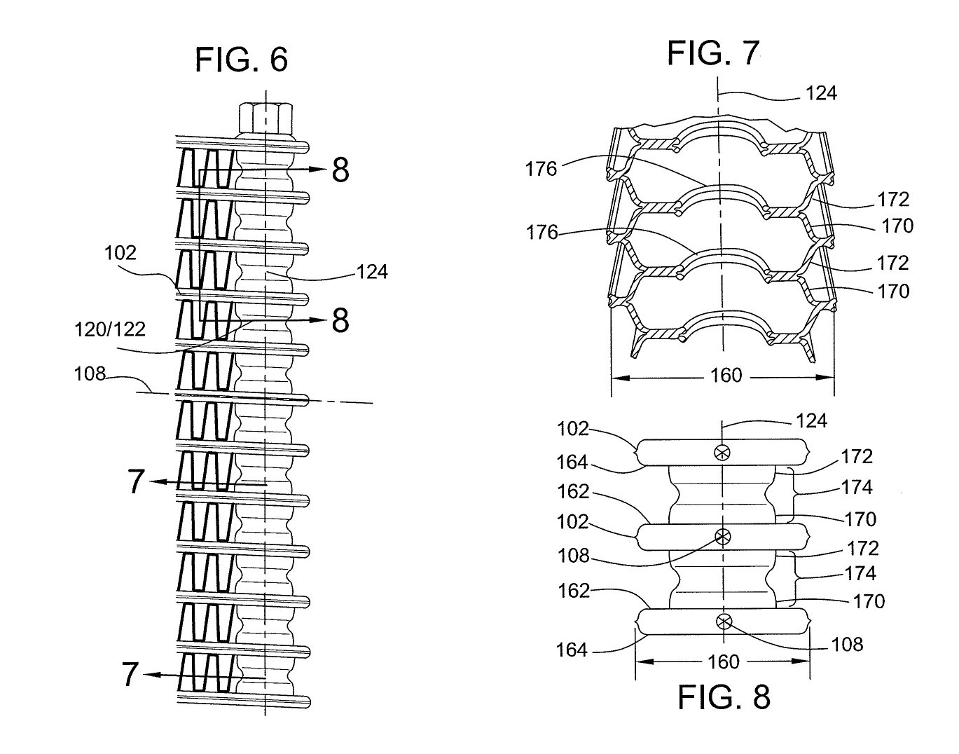

To enable flexible bending of the first and second manifolds while providing support for the heat exchanger, in an embodiment, the manifolds can be constructed as bellows-style manifolds. Referring to FIGS. 6-9, there is illustrated an example of a bellows manifold 120, 122 that can allow for deformation by way of extension and/or contraction to adjust its overall length and that is integral with the tubes 102 to accommodate their extension and contraction in the longitudinal direction. In this embodiment, the tubes 102 can have a flat cross-section 160 perpendicular to their longitudinal direction 108 with a flat upper surface 162 and an opposing flat lower surface 164 that delineates the longitudinal flow channel therebetween. In an embodiment, the upper surface 162 and lower surface 164 can be formed separately and welded together or, in another embodiment, they can be formed together as an extruded part.

Disposed at the first ends 104 of each tube 102 can be an upper boss 170 protruding upwards from the upper surface 162 and a lower boss 172 protruding downwards from the lower surface 164 such that the upper and lower bosses are generally aligned along the first manifold axis 124. The upper and lower bosses 170, 172 are hollow, made from thin-walled material and can have a domed or rounded cup-like shape with a decreasing diameter as they protrude away from the respective upper and lower surfaces 162, 164. The upper boss 170 of one tube 102 can merge or join with the lower boss 172 of an adjacent tube so that together the two form an hourglass contour that maybe referred to as a bellows 174. The hourglass shape and the thin-walled construction of the bellows 174 permits a degree of distortion to accommodate relative movement between adjacent tubes 102 and flexibility of the first and second manifolds 120, 122. For example, the contoured hourglass shape of the bellows 174 may allow the upper boss 170 to tilt with respect to the lower boss 172, enabling the entire manifold 120 to bend with respect to the first manifold axis 124. Additionally, the shape of the bellows 174 may allow a degree of expansion and contraction vertically in the direction indicated by the first manifold axis 124. To allow fluid to flow between adjacent tubes 102, referring to FIG. 7, a communication passage 176 can be disposed through the apexes of joined upper and lower bosses 170, 172. The joined upper and lower bosses 170, 172 can be formed as a single part or formed separately and joined to each other and the tubes by spot welding, brazing or the like. Corresponding upper and lower bosses can be formed at the aligned second ends of the tubes along the second side edge to provide the second bellows manifold.

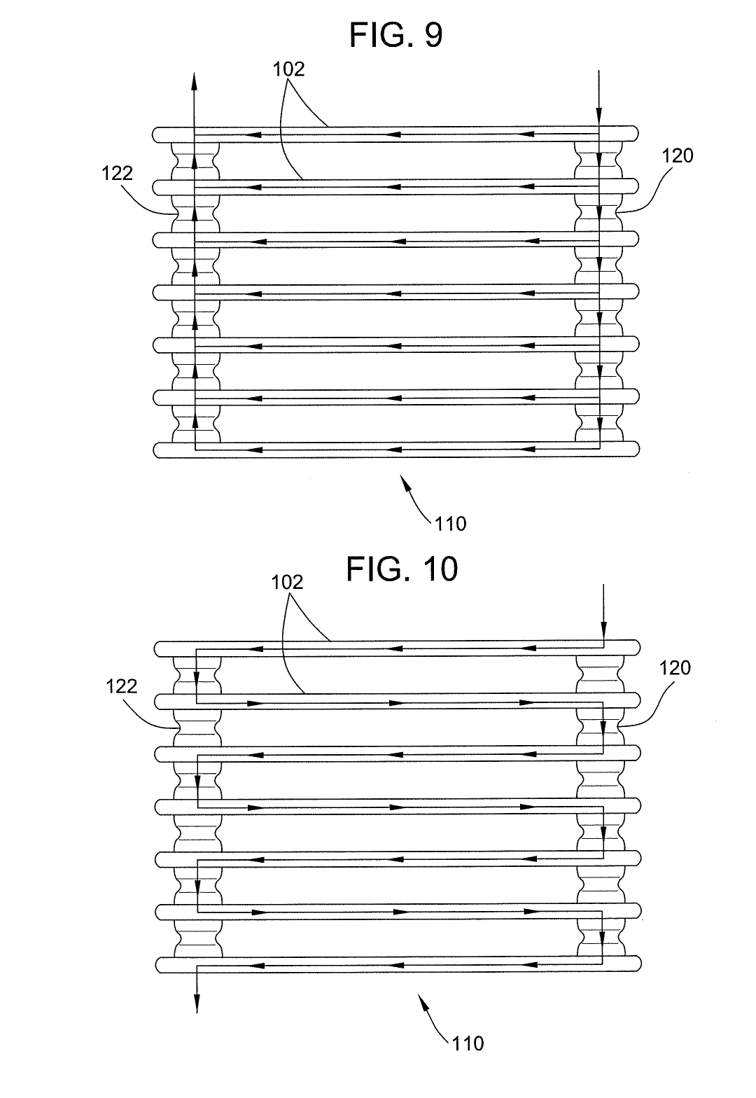

In the embodiment in which all the bellows both align along the manifold axes are in continuous fluid communication, the flow pattern or circuit through the heat exchanger may be referred to as a single pass pattern. As illustrated in FIG. 9, fluid entering the first manifold 120 is directed continuously in the vertical direction to access each of the tubes 102 in the plurality of the tubes. The fluid enters each of the tubes 102 and is redirected in the longitudinal direction to flow to the second manifold 122 where it exits the heat exchanger. All fluid flows in the same direction across the tube core 110. Hence, the fluid makes only a single pass across the width of the heat exchanger. In contrast, FIG. 10 illustrates a multipass pattern in which selective bellows have been blocked to prevent fluid flow continuously along the first and second manifolds. Instead, the fluid is selectively directed into alternating tubes 102 to flow back and forth between the first and second manifolds 120, 122 in a zigzag pattern. The fluid therefore makes multiple passes across the primary heat transferring area for additional cooling. The choice between single and multipass patterns depends upon heat load, fluid quantity, installation constraints etc., but either configuration can be used in accordance with the disclosure.

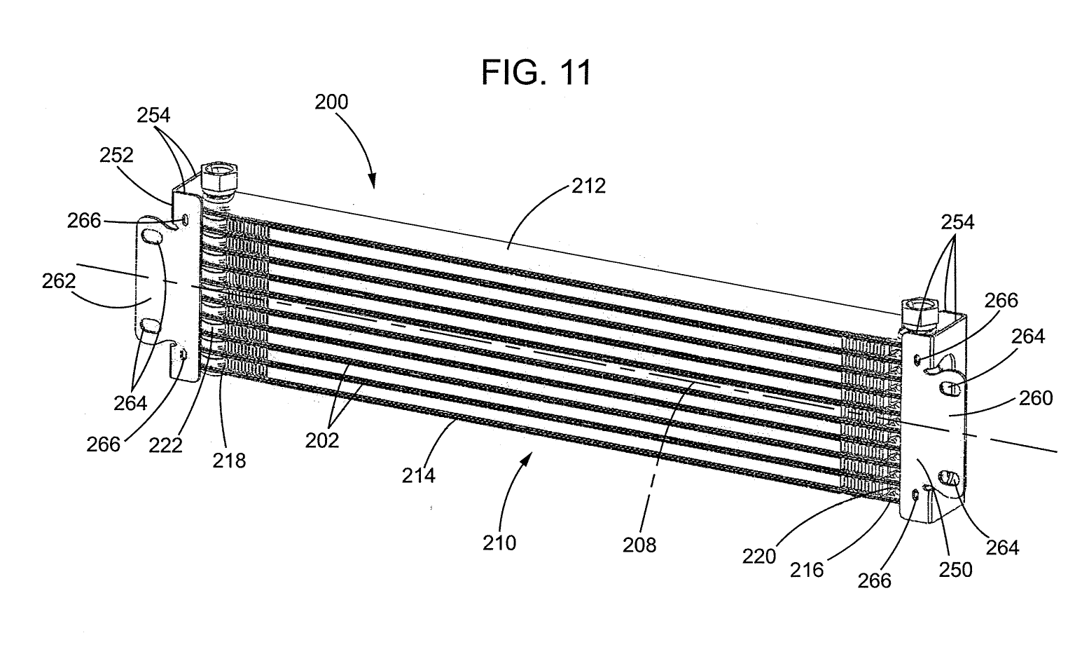

Referring to FIG. 11 there is illustrated another embodiment of a frameless heat exchanger 200 including first and second side brackets 250, 252 to facilitate installation of the heat exchanger to the chassis or engine compartment of an associated application. The heat exchanger 200 includes a plurality of elongated tubes 202 in a tube core 210 that extend longitudinally between a vertical first manifold 220 and a vertical second manifold 222. The tube core 210 accordingly has a rectangular shape including a top edge 212, a parallel bottom edge 214, a first side edge 216 and a parallel second side edge 218 that are generally perpendicular to the top and bottom edges. The heat exchanger 200 lacks a support frame and the first and second manifolds 220, 222 can be formed as bellows manifolds to provide a degree of flexibility to accommodate thermal expansion and contraction of the longitudinal tubes. Additionally, one or more of the tubes may be reinforced with respect to the other tubes in the plurality of tubes to better withstand thermal loading and provide structural rigidity to the heat exchanger.

To facilitate installation of the heat exchanger 200 in the absence of a support frame, a first side bracket 250 and a corresponding second side bracket 252 can be disposed along the respective first side edge 216 and second side edge 218 of the heat exchanger. The side brackets 250, 252 can be stamped or pressed from sheet metal or plate metal into a C-shaped or U-shape with three integral walls 254 bent at 90° angles to each other and that define an internal channel 256. When the first side bracket 250 is attached to the heat exchanger 200, the first side edge 216 can be received in the internal channel 256 so that the three integral walls 254 generally encompass the first manifold 220. The first side bracket 250 thereby protects the first manifold 220 from puncture or the like. The second side bracket 252 can be similarly disposed about the second side edge 218 and encompasses the second manifold 222. To physically attach the heat exchanger 200 to an attachment surface or the like, the first and second side brackets 250, 252 each can include a respective first and second ear-like, protruding mounting flange 260, 262 aligned with the longitudinal direction 208 and directed away from the tube core 210. The first and second mounting flanges 260, 262 can be flush with a face of the tube core 210 so as to install the bracket flush against a surface.

The first and second mounting flanges 260, 262 can include apertures 264 disposed therein that can receive mounting bolts, rivets, etc., to physically secure the heat exchanger to an installation feature on an associated machine or process. The dimensions and the locations of the apertures 264 can correspond with the installation patterns on prior art heat exchangers to facilitate retrofitting of existing machines or processes with the new heat exchangers. For example, a prior art heat exchanger having a support frame rigidly supporting a plurality of tubes and manifolds as described with respect to FIG. 1 can be removed from an existing apparatus or process. A frameless heat exchanger of the type described herein wherein the plurality of tubes are rigidly secured only at their first and second ends by the manifolds can be incorporated into the apparatus or process. Hence, existing applications or processes can be equipped with the frameless heat exchanger that accommodates thermodynamic expansion and contraction and mitigates problems arising from thermal stresses.

To ensure the first and second side brackets 250, 252 do not interfere with thermal-induced dimensional changes of the plurality of tubes 202 or the flexibility of the first and second manifolds 220, 222, the attachment between the side brackets and the heat exchanger 200 can be flexible and/or provide for play to allow relative motion between the brackets and the tube core. One of the three integral walls 254 can have one or more elongated slots 266 disposed through it to provide access to the respective first or second side edge 216, 218 of the tube core 210. The slots 266 can receive an appropriately located rod-like extension member such as a bolt or a dowel pin securely joined to and protruding from the tube core 210. Further, the slots 266 can be larger than the bolt or pin to allow relative motion of the bolt or pin within the static slots. In some embodiments, rubber or an elastomer can be disposed between the bolt or pin and the slots to dampen the relative motion as part of a feature sometimes referred to as an isolation mount. The slots 266 can allow for longitudinal and vertical motion of the tube core 210 with respect to the brackets 250, 252 that may be rigidly secured to an installation.

### INDUSTRIAL APPLICABILITY

The present disclosure is applicable to heat exchangers in general and particularly to heat exchangers that cool a process fluid heated by an associated application such as an internal combustion engine and that returns the fluid to the application. Referring to FIG. 2, heated fluid can be introduced to the heat exchanger 100 through the first manifold 120 that distributes the fluid to a plurality of tubes 102 extending across a tube core 110. The fluid is cooled as it is directed through the tubes 102 and the cooled fluid is received by the second manifold 122 that can return it to an application. The tubes 102 and the first and second manifolds 120, 122 can be arranged and interconnected in a manner to accommodate different degrees of thermal expansion and contraction occurring in the different components of the heat exchanger. For example, the tube core and the first and second manifold can be interconnected without the constraining support frame used in prior art heat exchangers. In such an embodiment, the tubes provide the primary structural support between the first and second manifolds. Using finite element analysis, it has been determined that in some embodiments elimination of the support frame and use of the tubes to support the heat exchanger can reduce thermal and mechanical stresses occurring in prior art heat exchangers by about 2%.

To accommodate thermal expansion and contraction of the tubes, in an embodiment, the plurality of the tubes 102 can be grouped into reinforced first tubes 140 and standard second tubes 150. The reinforced first tubes 140 can be disposed at a top edge 112 of the heat exchanger 100 and can provide structural rigidity in the longitudinal direction 108 while allowing the standard second tubes 150 to expand and contract. In another embodiment, the first and second manifolds 120, 122 can be flexible so that they can bend in concave and convex directions as the plurality of tubes expand and contract. To improve the flexibility of the manifolds, the manifolds can be formed to function as bellows.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A frameless heat exchanger comprising:
a plurality of tubes, each extending between a first end and a second end thereof;
the plurality of tubes arranged parallel to and aligned with each other to form a tube core wherein each tube is attached to an adjacent tube at the first end and at the second end thereof;
at least a portion of the plurality of tubes in fluid communication with adjacent tubes at the first ends to form a first manifold and at least a portion of the plurality of tubes in fluid communication with adjacent tubes at the second ends to form a second manifold;
wherein the plurality of tubes and the first and second manifolds are interconnected for relative movement of the plurality of tubes and to accommodate thermal expansion and contraction of the plurality of tubes.

2. The frameless heat exchanger of claim 1, wherein the plurality of tubes includes a reinforced first tube reinforced with respect to a standard second tube.

3. The frameless heat exchanger of claim 2, wherein the reinforced first tube includes a first tube wall that is thicker than a second tube wall of the standard second tube.

4. The frameless heat exchanger of claim 3, wherein the reinforced first tube is proximate a top edge of the tube core.

5. The frameless heat exchanger of claim 1, wherein the first manifold and the second manifold are arranged generally perpendicular to the plurality of tubes.

6. The frameless heat exchanger of claim 5, wherein the first manifold and the second manifold are sufficiently bendable to accommodate thermal expansion and contraction of the plurality of tubes in a direction parallel to and perpendicular to the first manifold and the second manifold.

7. The frameless heat exchanger of claim 1, wherein the tube core is generally rectangular and includes a first side edge, a second side edge, a top edge, and a bottom edge.

8. The frameless heat exchanger of claim 7, further comprising a first side bracket flexibly attached to the tube core along the first side edge and partially encompassing the first manifold and a second side bracket flexibly attached to the tube core along the second side edge and partially encompassing the second manifold.

9. The frameless heat exchanger of claim 8, wherein the first side bracket includes at least one slot disposed therethrough, the slot receiving an extension member extending from at least one of the tube core and the first manifold.

10. A method of assembling a frameless heat exchanger comprising;
forming a plurality of tubes, each tube extending between a first end and a second end;
arranging the plurality of tubes into a tube core wherein each tube is parallel to and longitudinally aligned with each other tube and the first ends are aligned along a first side edge of the tube core and the second ends are aligned along a second side edge of the tube core; and
securing the plurality of tubes in the tube core together by joining the first ends with each other and joining the second ends with each other such that the first ends and the second ends are the primary structural connection between the plurality of tubes.

11. The method of claim 10, wherein each tube includes a tube wall delineating a hollow internal channel, a first tube wall of a first tube among the plurality of tubes being thicker than a second tube wall of a second tube among the plurality of tubes.

12. The method of claim 11, wherein the first tube is proximate a top edge of the tube core.

13. The method of claim 10, wherein joints between the first ends and joints between the second ends are sufficiently flexible to accommodate thermal expansion and contraction of the plurality of tubes.

14. The method of claim 10, wherein the tube core is generally rectangular and includes a top edge and a bottom edge extending between the first side edge and the second side edge.

15. A frameless heat exchanger for transferring heat from a fluid circulating therein to a surrounding environment, the heat exchanger comprising:
a plurality of tubes, each tube extending between a first end and a second end to define a longitudinal direction, the plurality of tubes arranged parallel to and aligned with each other along the longitudinal direction to form a tube core;
each tube having a generally flat cross-section normal to the longitudinal direction, the flat-cross section defining opposing upper and lower surfaces;
a cup-shaped upper boss at each of the first and second ends protruding upwards from the upper surface, the upper bosses generally perpendicular to the longitudinal direction;
a cup-shaped lower boss at each of the first and second ends protruding downwards from the lower surface, the lower bosses generally perpendicular to the longitudinal direction;
wherein the upper bosses and the lower bosses at the first ends align together to form a first bellows manifold, and the upper bosses and the lower bosses at the second end align to form a second bellows manifold, and
wherein the tube core is structurally supported by the plurality of tubes and the first and second bellows manifolds.

16. The frameless heat exchanger of claim 15, wherein the tube core is generally rectangular and includes a first side edge, an opposing second side edge, a top edge and a bottom edge.

17. The frameless heat exchanger of claim 16, wherein the first bellows manifold is disposed along and coupled to the first side edge and the second bellows manifold is disposed along and coupled to the second side edge to flex in at least one of a concave and convex manner to accommodate thermal expansion and contraction of the plurality of tubes.

18. The frameless heat exchanger of claim 17, wherein each tube includes a tube wall delineating a hollow internal channel, a first tube wall of a first tube among the plurality of tubes being thicker than a second tube wall of a second tube among the plurality of tubes.

19. The frameless heat exchanger of claim 18, wherein the first tube is at the top edge of the tube core.

20. The frameless heat exchanger of claim 15 wherein adjacent tubes in the tube core are spaced-apart from each other by a distance; and the frameless heat exchanger further comprises fins disposed between adjacent tubes in the tube core, the fins facilitating transfer of heat from the fluid to the surrounding environment.

21. The frameless heat exchanger of claim 15, further comprising an uppermost tube at the top edge of the tube core and a lowermost tube at the bottom edge of the tube core, wherein the upper surface of the uppermost tube lacks fins and the lower surface of the lowermost tube lacks fins.

22. A method of retrofitting a heat exchanger system to reduce thermal stress failures comprising:
removing from the heat exchanger system a first heat exchanger including a first tube core having a plurality of parallel first tubes rigidly secured by a support frame; and
incorporating into the heat exchanger system a second heat exchanger including a second tube core having a plurality of second tubes, each of the second tubes extending from a first end to a second end, wherein the plurality of second tubes are rigidly secured only at the first ends and the second ends.
